(19) United States
(12) Patent Application Publication
(10) Pub. No.: US 2013/0260362 A1
(43) Pub. Date: Oct. 3, 2013

(54) CONFIGURABLE PANEL DISPLAY

(71) Applicant: CALAPITTER CREATIONS, INC., Great Falls, MT (US)

(72) Inventors: Connie Melashenko, Great Falls, MT (US); Dale William Woiken, Upland, CA (US)

(73) Assignee: Calapitter Creations, Inc., Great Falls, MT (US)

(21) Appl. No.: 13/854,698

(22) Filed: Apr. 1, 2013

Related U.S. Application Data
(60) Provisional application No. 61/619,135, filed on Apr. 2, 2012.

(51) Int. Cl. G09B 19/00

(52) U.S. Cl. CPC G09B 19/00
USPC 434/430

(57) ABSTRACT

A configurable panel display includes panel frames configurable to support respective panels, adjacent ones of the panel frames being pivotably connected along opposing edges, each panel frame having intersecting sides formed by tubular frame members, and a cap hinge assembly pivotably connecting two adjacent ones of the panel frames. Each cap hinge assembly includes two frame corner pieces, each frame corner piece interconnecting tubular frame members of two intersecting sides of a respective one of the adjacent ones of the panel frames. Each frame corner piece includes projections received within the interconnected tubular frame members, a central corner piece body from which each of the projections integrally extends, a hinge cap spanning the two frame corner pieces, and two threaded fasteners, each threaded fastener connecting the hinge cap to a respective one of the frame corner pieces.

### CROSS REFERENCE TO RELATED APPLICATION

This application claims the benefit under 35 U.S.C. §119(e)(1) of U.S. Provisional Application No. 61/619,135, filed on Apr. 2, 2012, which is incorporated by reference herein.

### TECHNICAL FIELD

This invention relates to a configurable panel display, and more particularly to a hinged panel display that can be configured for a variety of children's activities, and to a cap hinge useful for such hinged panel displays and other systems.

### BACKGROUND

Providing entertaining and engaging children's activities is an important objective of individuals who supervise children, such as classroom teachers and daycare staffers. Furthermore, supervisors should be able to provide these activities in a feasible manner that is time-efficient and minimal in setup tasks. While a variety of children's activities can be provided in children's venues, those that are focused at a central activity station or a play station can be particularly desirable. In particular, configurable structures that provide a variety of children's activities can serve as time-efficient, space-saving, multi-use stations for children's venues.

### SUMMARY

The invention involves a realization that certain attributes of a configurable panel display can provide a variety of viewable and interactive children's activity stations that may include one or more areas for displaying attachable and removable viewing objects.

One aspect of the invention features a configurable panel display that includes multiple panel frames and a cap hinge assembly. The multiple panel frames are configurable to support respective panels, where adjacent ones of the panel frames are pivotably connected along opposing edges such that the configurable panel display is foldable to a state in which the adjacent ones of the panel frames are overlapped and parallel, where each panel frame has intersecting sides formed by tubular frame members. The cap hinge assembly pivotably connects two adjacent ones of the panel frames and includes two frame corner pieces, a hinge cap, and two threaded fasteners. Each frame corner piece interconnects tubular frame members of two intersecting sides of a respective one of the adjacent ones of the panel frames and includes projections and a central corner piece. The projections are received within the interconnected tubular frame members, and the central corner piece body from which each of the projections integrally extends defines a threaded hole extending inward from a shoulder of the central corner piece body. The hinge cap spans the two frame corner pieces, and each threaded fastener connects the hinge cap to a respective one of the frame corner pieces. Each threaded fastener has a shoulder bearing against the shoulder of the central corner piece body of the respective one of the frame corner pieces and has a head spaced from the shoulder of the fastener a distance sufficient to allow the hinge cap to rotate with respect to the threaded fastener with the threaded fastener tightly secured to the respective one of the frame corner pieces, thereby allowing the two frame corner pieces to each independently pivot with respect to the hinge cap.

In some implementations, the hinge cap defines a mounting aperture disposed between the threaded fasteners and open at an exposed surface of the cap.

In some examples, the configurable panel display further includes a display foot secured to the hinge cap at the mounting aperture and extending from the exposed surface of the cap.

In some cases, the two threaded fasteners are secured to the hinge cap with clips.

In some instances, the threaded hole is defined by a threaded insert secured within the central corner piece body.

In some implementations, the projections have interference detents that bear against inner surfaces of the tubular frame members to secure the cap hinge assembly to the adjacent ones of the panel frames.

In some examples, the opposing edges of the panel frames each include multiple tubular frame members joined by a connector to form a single, linear frame edge, where each connector has projections received within the multiple tubular frame members.

In some cases, one of the tubular frame members forms an upper edge of one of the panel frames and includes a poster hanger.

In some instances, the configurable panel display of further includes panels supported by and spanning respective ones of the panel frames.

In some implementations, at least one of the panels includes a laminate with a solid core between surface coverings, where one of the surface coverings provides a relatively smooth, non-porous surface suitable for non-adhesively supporting flexible sheets.

In some examples, at least one of the panels has a magnetically attractable surface.

In some cases, the solid core is a foam board.

In some instances, the panel includes a perimeter frame extending about the laminate, where edges of the laminate extend into channels of the perimeter frame.

In some implementations, the perimeter frame defines grooves extending along opposite sides of edges of the panel, where ribs of the tubular frame members of the panel frames are received within the grooves and secure the panels to the panel frames.

In some examples, the panels each have a thickness measured between broadest sides of the panel, where the panel frames are of a greater thickness than the panels.

In some cases, the adjacent ones of the panel frames each have a thickness, and first and second rotation axes defined by the cap hinge assembly are spaced apart a distance at least as great as half the sum of the thicknesses of the adjacent ones of the panel frames, such that the adjacent ones of the panel frames are pivotable with respect to each other to place the adjacent ones of the panel frames in an overlapped, parallel relation.

In some instances, the adjacent ones of the panel frames are each rotatable about the cap hinge assembly through an angle of at least 180 degrees, such that the adjacent ones of the panel frames are pivotable in either of two directions to place the adjacent ones of the panel frames in an overlapped, parallel relation.

In some implementations, the configurable panel display includes at least three panel frames connected in series by cap hinge assemblies and foldable to place distal vertical edges of the configurable panel display adjacent one another, thereby forming a three-dimensional structure having a polygonal footprint.

In some examples, the configurable panel display includes a middle panel frame disposed between and pivotably connected to two side panel frames by hinge cap assemblies, and a middle panel supported by and spanning a width of a lower portion of the middle panel frame, where the middle panel frame spans an opening above the middle panel.

In some cases, the configurable panel display further includes a drape depending from an upper edge of the middle panel frame into the opening, such that the configurable panel display is configurable as a puppet theatre.

In some instances, the configurable panel display further includes two rows of pegs disposed on opposite sides of the opening, where the pegs are aligned to form an educational loom.

In some implementations, the configurable panel display further includes one or more removable, flexible overlay panels secured to and spanning the panel frames.

The configurable panel display described herein can provide an educator, for example, with a readily configurable and storable structure with surfaces suitable for holding and displaying various educational materials or materials for interactive play. The configurable panel display is adaptable into many configurations, including certain configurations featuring panels of various heights and accessories for puppetry or weaving activities, for example.

The cap hinge assembly is particularly useful for enabling such a structure to be readily folded flat for storage without disassembly of the hinged joints, and for quick disconnection of the panels without tools, such as for reconfiguration. Manipulation of the cap hinge assembly to connect or disconnect adjacent portions of the configurable panel display is relatively intuitive, and the hinge components can be fashioned and assembled at a relatively low cost.

The details of one or more embodiments of the invention are set forth in the accompanying drawings and the description below. Other features, aspects, and advantages of the invention will be apparent from the description, drawings, and claims.

### BRIEF DESCRIPTION OF THE DRAWINGS

FIG. 1 is a perspective view of a hinged frame.

FIG. 2 is an exploded perspective view of the hinged frame of FIG. 1.

FIG. 3 is a cross-sectional view of a vertical frame member of the hinged frame of FIG. 1.

FIG. 4 is a cross-sectional view of a horizontal frame member of the hinged frame of FIG. 1.

FIG. 5 is an exploded perspective view of a cap hinge of the hinged frame of FIG. 1.

FIG. 6 is a perspective cross-sectional view of the cap hinge of FIG. 5.

FIG. 7 is a perspective view of a frame foot of the hinged frame of FIG. 1.

FIG. 8 is a perspective view of a hinged panel display.

FIG. 9 is an exploded perspective view of the hinged panel display of FIG. 8.

FIG. 10 is a cross-sectional view of a vertical frame member of the hinged frame of FIG. 1.

FIG. 11 is a cross-sectional view of a horizontal frame member of the hinged frame of FIG. 1.

FIG. 12 is an exploded perspective view of a panel of the hinged panel display of FIG. 8.

FIG. 13 is a perspective cross-sectional view of the panel of FIG. 12.

FIG. 14 is an example perspective cross-sectional view of the hinged panel display of FIG. 8.

FIG. 15 is a perspective view of a hinged panel display.

FIG. 16 is a perspective cross-sectional view of the horizontal frame member of FIG. 4 as assembled with a strip of fastener material.

FIG. 17 is a rear view of a detachable overlay panel that can be affixed to the horizontal frame member of FIG. 4.

FIG. 18 is a cross-sectional view of a portion of the detachable overlay panel of FIG. 17.

FIG. 19 is an example view of the hinged frame of FIG. 1 assembled with poster hangers and a poster bar.

FIG. 20 is rear view of a poster that can be releasably attached to the poster bar of FIG. 19 or to the strip of fastener material of FIG. 16.

FIG. 21 is an example view of a wall hook affixed to the hinged frame of FIG. 1.

FIG. 22 is a perspective view of a hinged frame.

FIG. 23 is a perspective view of a hinged panel display arranged in a partially closed configuration.

FIG. 24 is a perspective view of a hinged panel display arranged in a folded-flat configuration.

FIG. 25 is an example view of the hinged panel displays of FIG. 8 and FIG. 15, as disassembled for transport.

FIG. 26 is a perspective view of a hinged panel display configured as a puppet theatre.

FIG. 27 is an exploded perspective view of the puppet theatre of FIG. 26.

FIG. 28 is a cross-sectional view of a shelf of the puppet theatre of FIG. 26.

FIG. 29 is a perspective view of the hinged frame of FIG. 1 as assembled with a weaving loom assembly.

Like reference symbols in the various figures indicate like elements.

### DETAILED DESCRIPTION

A hinged panel display configurable for a variety of children's activities will be described below. In some implementations, the hinged panel display can provide one or more display areas for attachable and removable viewing objects, such as stickers, posters, and murals. In some examples, the hinged panel display can be arranged or configured to provide a viewable activity station (e.g., to display a large story board, a report, or a poster) or an interactive activity station (e.g., a puppet theatre or a weaving loom). In some instances, the hinged panel display may be utilized within any number of children's venues, such as classrooms and daycare centers. In some examples, the hinged panel display may be utilized by individual consumers.

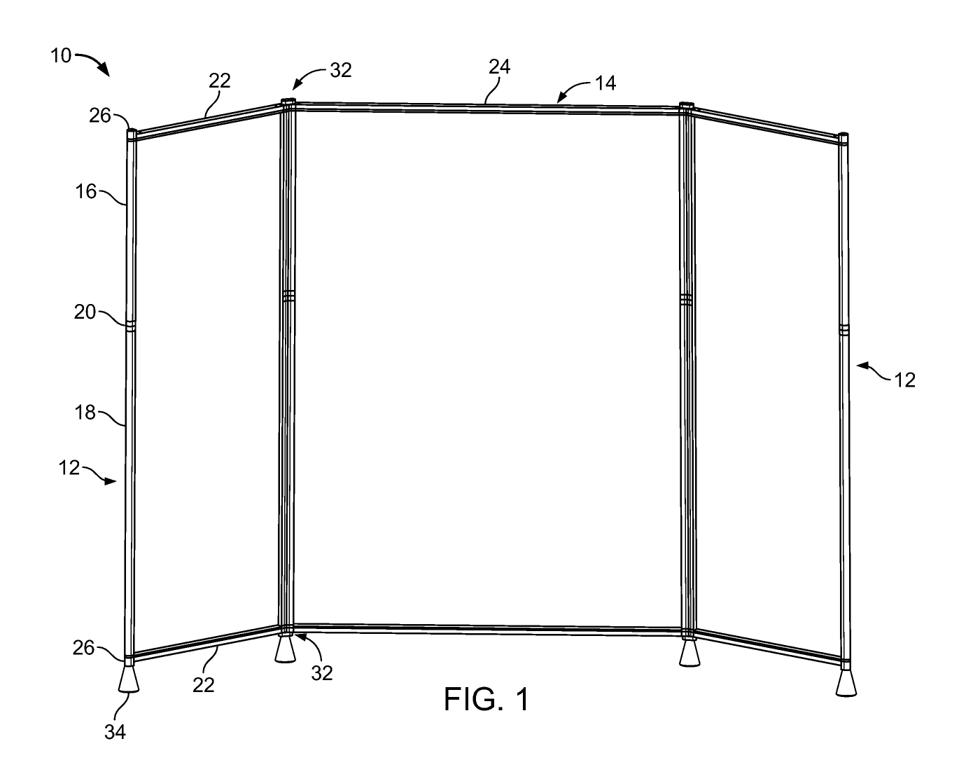

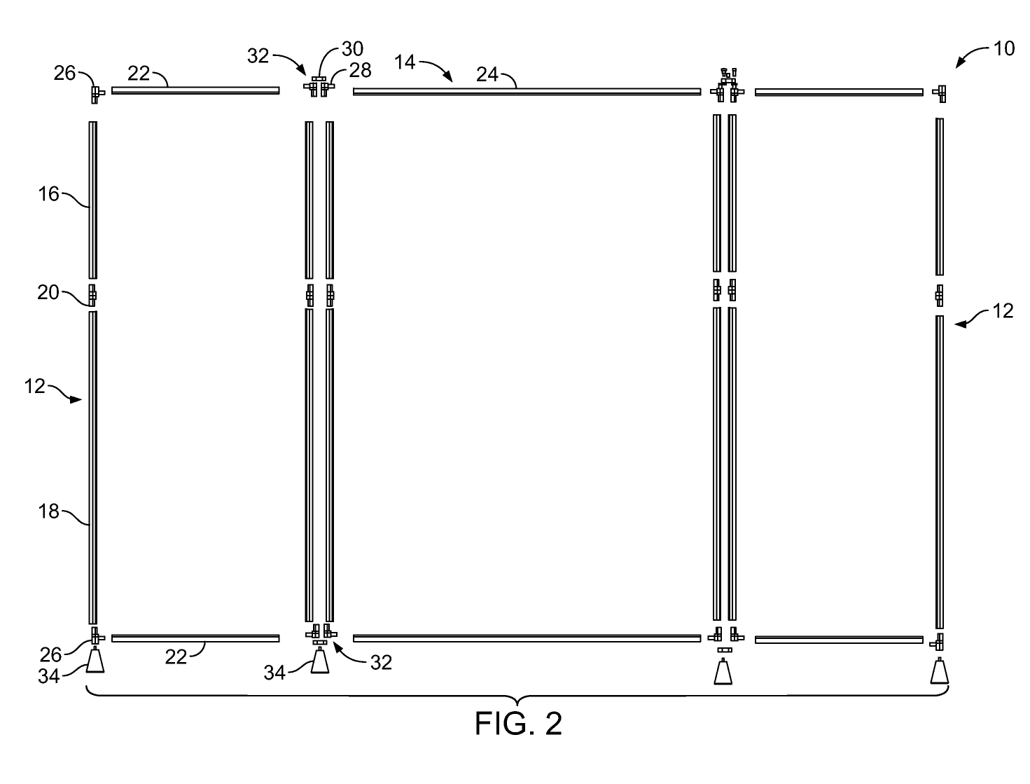

FIGS. 1 and 2 display a hinged frame 10 assembled with two end frames 12 and a center frame 14 positioned between end frames 12. Each frame 12, 14 includes two spaced apart short vertical frame members 16 and two spaced apart long vertical frame members 18. A vertical frame connector 20 vertically couples each short vertical frame member 16 to one long vertical frame member 18. Each end frame 12 further includes two spaced apart short horizontal frame members 22, and center frame 14 further includes two spaced apart long horizontal frame members 24. A corner frame connector 26 couples each outer vertical frame member 16, 18 to one short horizontal frame member 22, and a hinge connector 28 couples each inner vertical frame member 16, 18 to one short horizontal frame member 22. Two adjacent hinge connectors 28 and a hinge cap 30 cooperate to form a cap hinge 32, which pivotably couples end frame 12 to center frame 14. Frame feet 34 extend from lower corner frame connectors 26 and lower cap hinges 32 and provide additional height to hinged frame 10. In one embodiment, hinged frame 10 (as assembled with frame feet 34) has a height of approximately 60 in and a width of approximately 84 in. In some embodiments, hinged frame 10 may not include frame feet 34.

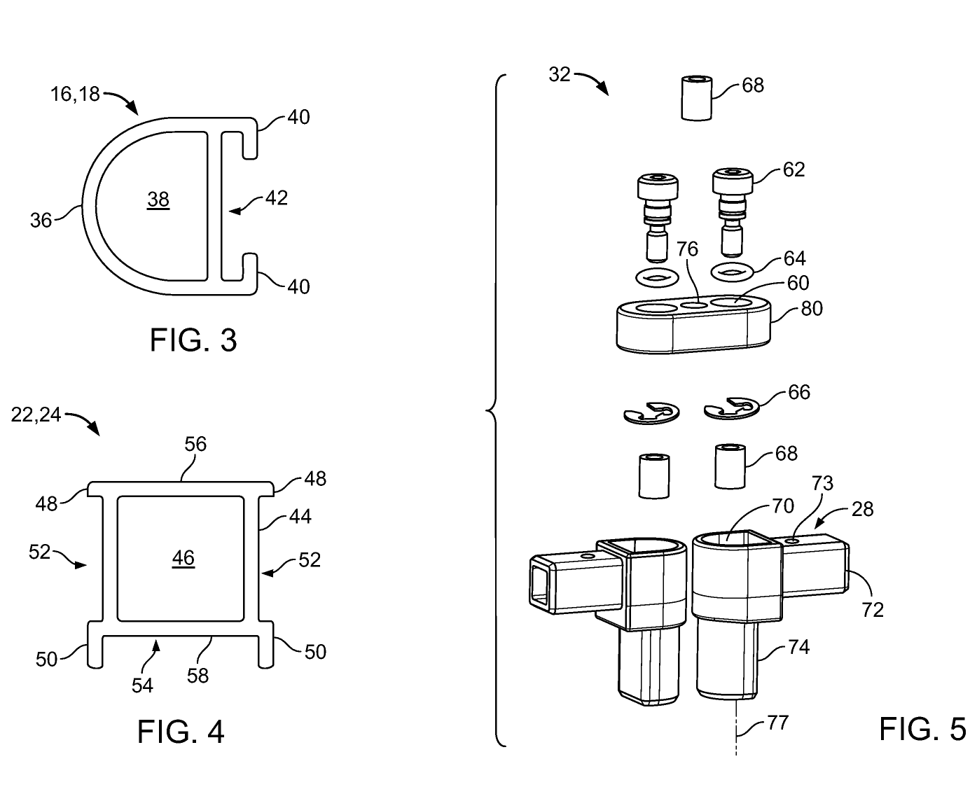

FIG. 3 displays a cross-sectional view of vertical frame members 16, 18. Each vertical frame member 16, 18 has a rounded wall 36 forming a D-shaped channel 38 and from which opposing flanges 40 extend to form a T-shaped slot 42. D-shaped channel 38 is sized and shaped to engage vertical frame connectors 20, corner frame connectors 26, and hinge connectors 28. In one embodiment, short vertical frame member 16 has an approximate length of 18 in, and long vertical frame member 18 has an approximate length of 36.5 in.

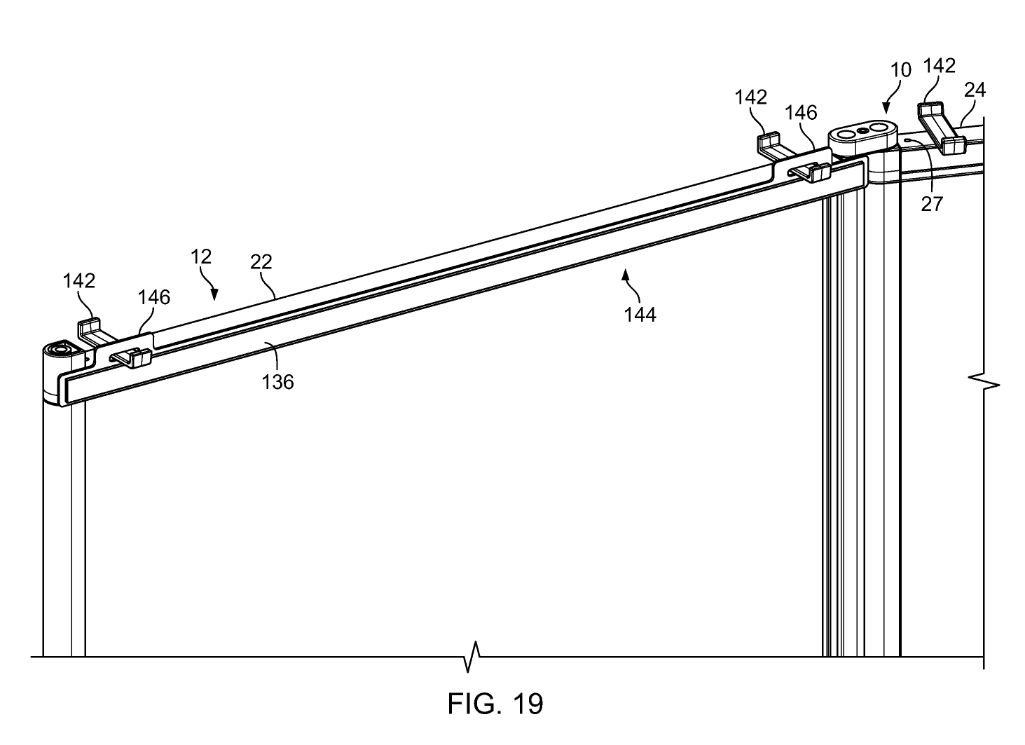

FIG. 4 displays a cross-sectional view of horizontal frame members 22, 24. Each horizontal frame member 22, 24 has a rectangular wall 44 forming a square-shaped channel 46 and from which opposing protrusions 48 and opposing flanges 50 extend. One protrusion 48 along with one flange 50 forms an elongate recess 52, while two opposing flanges 50 form an elongate slot 54. Square-shaped channel 46 is sized and shaped to engage corner frame connectors 26 and hinge connectors 28. Each horizontal frame member 22, 24 further includes an inner set of two spaced apart holes (not shown) positioned on a first surface 56 near ends of horizontal frame member 22, 24 and that are sized to accept various components, such as poster hangers (as will be discussed in more detail below). Each horizontal frame member 22, 24 further includes an outer set of two spaced apart holes 27 (shown in FIG. 19) positioned on first surface 56 near ends of horizontal frame member 22, 24 (where the outer set of holes are positioned closer to the ends of horizontal frame members 22, 24 than are the inner set of holes). The outer holes are sized to engage detents disposed on surfaces of hinge connectors 28 for securing cap hinge assembly 32 to horizontal frame members 22, 24 (as will be discussed in more detail below). Another hole (not shown) is positioned at a center of an opposing second surface 58 of long horizontal frame member 24 and is sized to engage a vertical connector (as will be discussed in more detail below). In one embodiment, short horizontal frame member 22 has an approximate length of 19.5 in, and long horizontal frame member 24 has an approximate length of 40.5 in.

Vertical and horizontal frame members 16, 18, 22, 24 may be constructed from any materials suitable to provide a relatively rigid hinged frame 10 as assembled, such as wood, plastic, or metal.

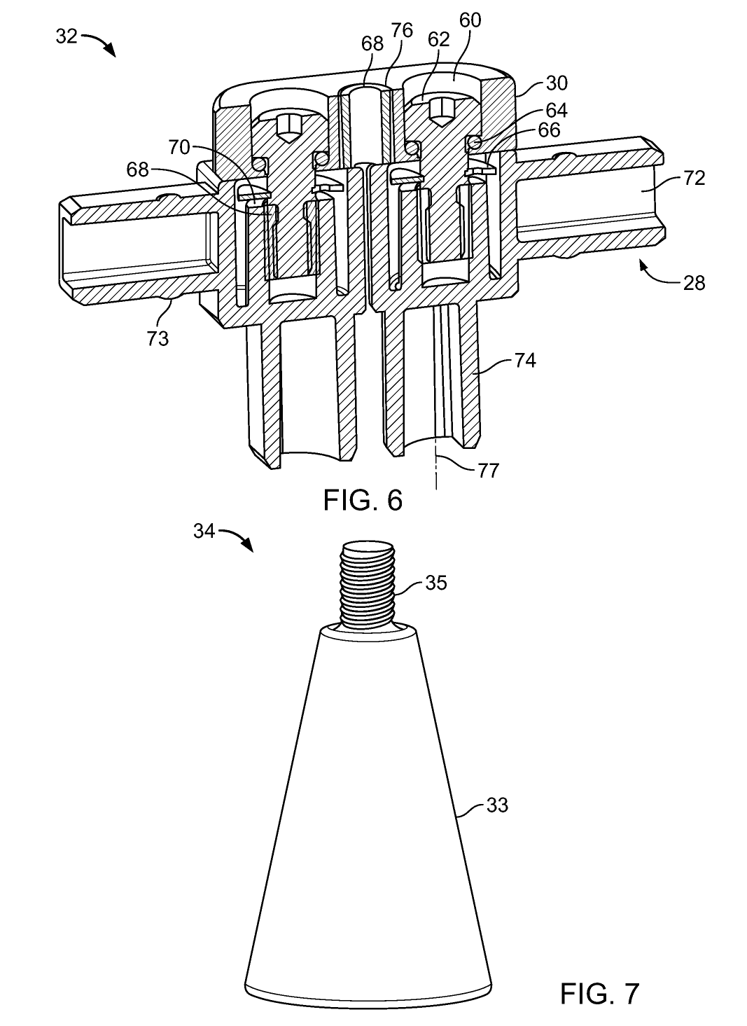

FIGS. 5 and 6 display a perspective view of cap hinge 32 as unassembled and a cross-sectional view of cap hinge 32 as assembled, respectively. Hinge cap 30 includes two opposing fastener seats 60 sized to accept fasteners 62 and O-rings 64 that secure fasteners 62 within fastener seats 60. In some examples, fasteners 62 may be shoulder screws. E-clips 66 retain fasteners 62 within fastener seats 60, and fasteners 62 engage threaded inserts 68 disposed within recesses 70 of hinge connectors 28. Each hinge connector 28 has a square-shaped projection 72 sized to fit within square-shaped channels 46 of horizontal frame members, 22, 24. A detent 73 extends from top and bottom surfaces of each square-shaped projection 72 and is formed to engage the outer set of holes 27 disposed along first surface 56 of horizontal frame members 22, 24 for locking square-shaped projections 72 securely into place within horizontal frame members 22, 24. Each hinge connector 28 also has a D-shaped projection 74 sized to fit within D-shaped channels 38 of vertical frame members 16, 18 and that extends perpendicular to square-shaped projection 72. A threaded insert 68 is disposed within a through-hole 76 that extends through a center of hinge cap 30 and can be used for attaching other components (e.g., frame feet 34) to the hinged frame 10. In one embodiment, threaded inserts 68 are press-fit into recesses 70 of hinge connectors 28 and through-hole 76 of hinge cap 30. Cap hinge 32 allows two adjacent frames 16, 18 to pivot with respect to one another about central axes 77 of D-shaped projections 74 such that hinged frame 10 can be arranged in variety of configurations.

Referring to FIG. 7, frame foot 34 includes a base 33 and a threaded connector 35 extending from a center of base 33. Threaded connector 35 is formed to engage threaded insert 68 disposed within through-hole 70 of hinge cap 30. Frame feet 34 may be constructed of any materials suitably rigid to withstand a weight of assembled hinged frame 10, such as wood, plastic, or metal. In one example, frame feet 34 can include a hollow region that may be filled with sand or another material such that frame feet 34 are weighted down to provide additional stability for hinged frame display 10. In some examples, frame feet 34 can include a wheel (not shown), allowing hinged frame 10 to be rolled about a floor surface.

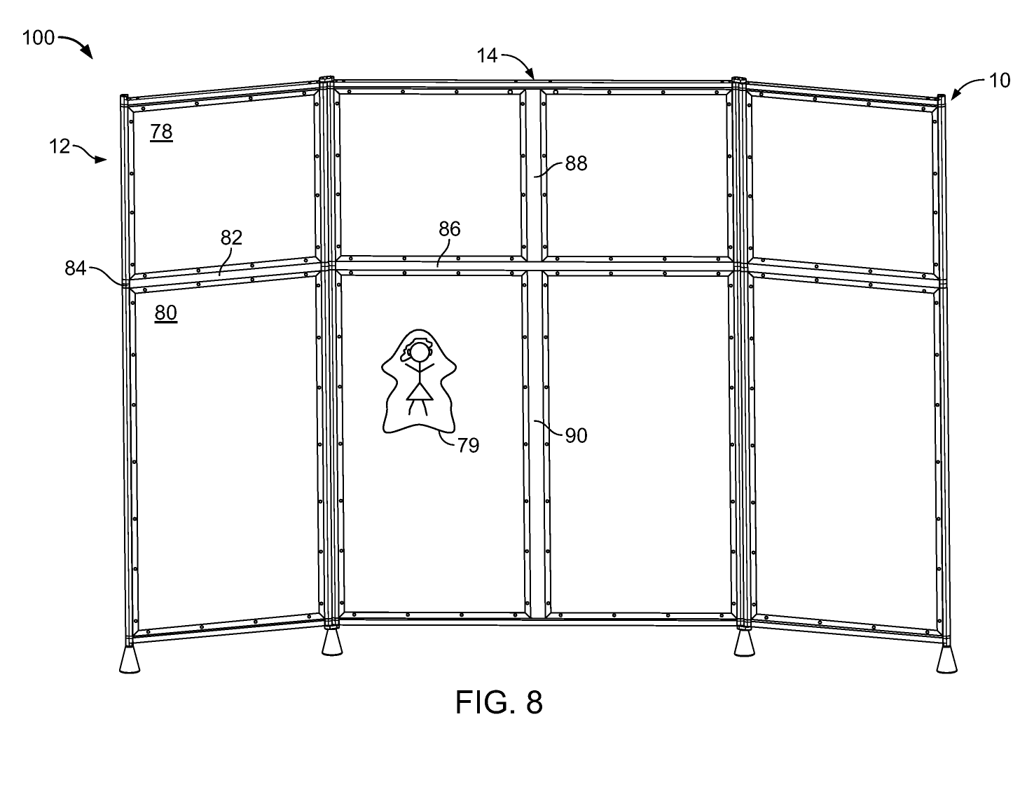

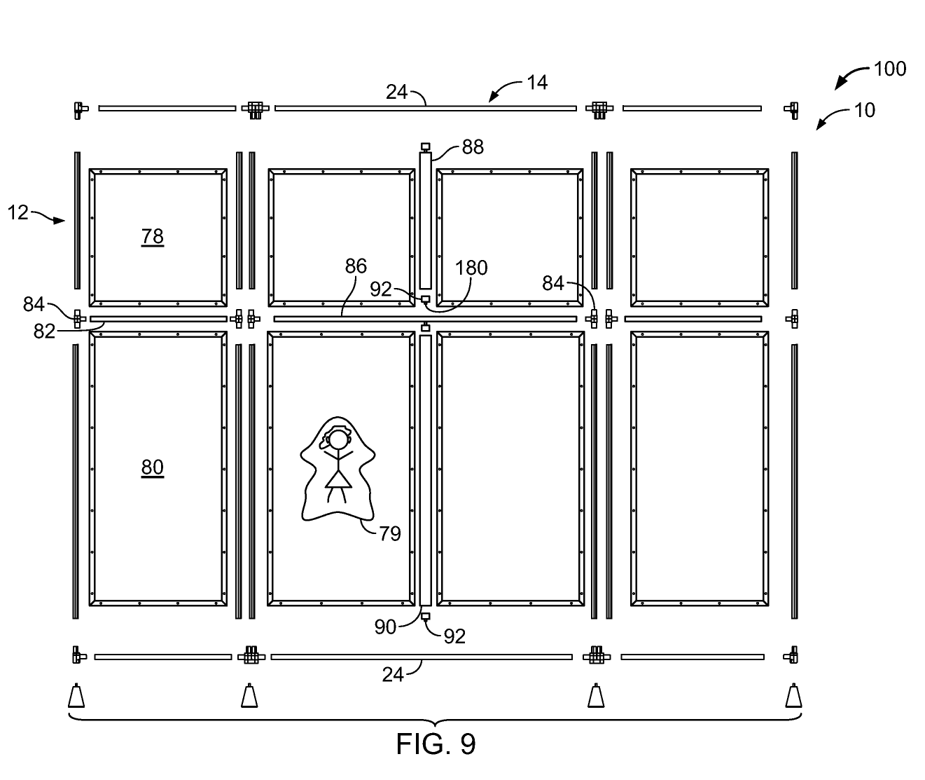

FIGS. 8 and 9 display assembled and an unassembled views, respectively, of a hinged panel display 100 that includes hinged frame 10 assembled with four small-sized panels 78 and four intermediate-sized panels 80 upon which various components, such as stickers 79, can be releasably attached. Each end frame 12 is assembled with one small-sized panel 78, one intermediate-sized panel 80, and a short horizontal frame member 82 that is positioned between small-sized panel 78 and intermediate-sized panel 80. Short horizontal frame member 82 is coupled to vertical frame members 16, 18 with opposing panel connectors 84. Each center frame 14 is assembled with two small-sized panels 78, two intermediate-sized panels 80, a long horizontal frame member 86 that is positioned between small-sized panels 78 and intermediate-sized panels 80, a short vertical frame member 88 that is positioned between small-sized panels 78, and an intermediate-length vertical frame member 90 that is positioned between intermediate-sized panels 80. Long horizontal frame member 86 is laterally coupled to vertical frame members 16, 18 with opposing panel connectors 84. Vertical frame members 88, 90 are coupled to long horizontal frame members 24, 86 with tube connectors 92 that seat within vertical frame members 88, 90 on one end and engage center holes within long horizontal frame members 24, 86 on an opposite end.

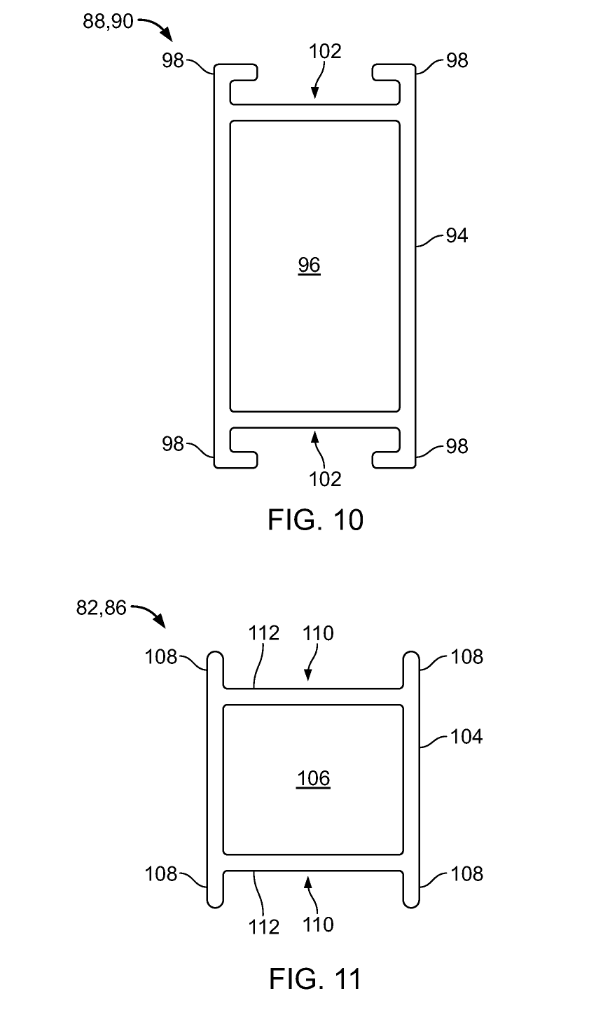

FIG. 10 displays a cross-sectional view of vertical frame members 88, 90. Each vertical frame member 88, 90 has a rectangular wall 94 forming a rectangular-shaped channel 96 and from which two sets of opposing flanges 98 extend to form opposing t-shaped slots 102. Rectangular-shaped channel 96 is sized and shaped to engage tube connector 92. In one embodiment, short vertical frame member 88 has an approximate length of 18 in, and intermediate-length vertical frame member 90 has an approximate length of 36.5 in.

FIG. 11 displays a cross-sectional view of horizontal frame members 82, 86. Each horizontal frame member 82, 86 has a rectangular wall 104 forming a rectangular-shaped channel 106 and from which two sets of opposing protrusions 108 extend to form opposing elongate recesses 110. Channel 106 is sized and shaped to engage panel connector 84. A hole (not shown) is positioned at a center of each surface 112 forming elongate recesses 110 of long horizontal frame member 86 and are sized to engage vertical tube connector 92. In one embodiment, short horizontal frame member 82 has an approximate length of 19.5 in, and long horizontal frame member 86 has an approximate length of 40.5 in.

Horizontal and vertical frame members 82, 86, 88, 90 may be constructed from any materials suitable to provide a relatively rigid hinged panel display 100 as assembled, such as wood, plastic, or metal.

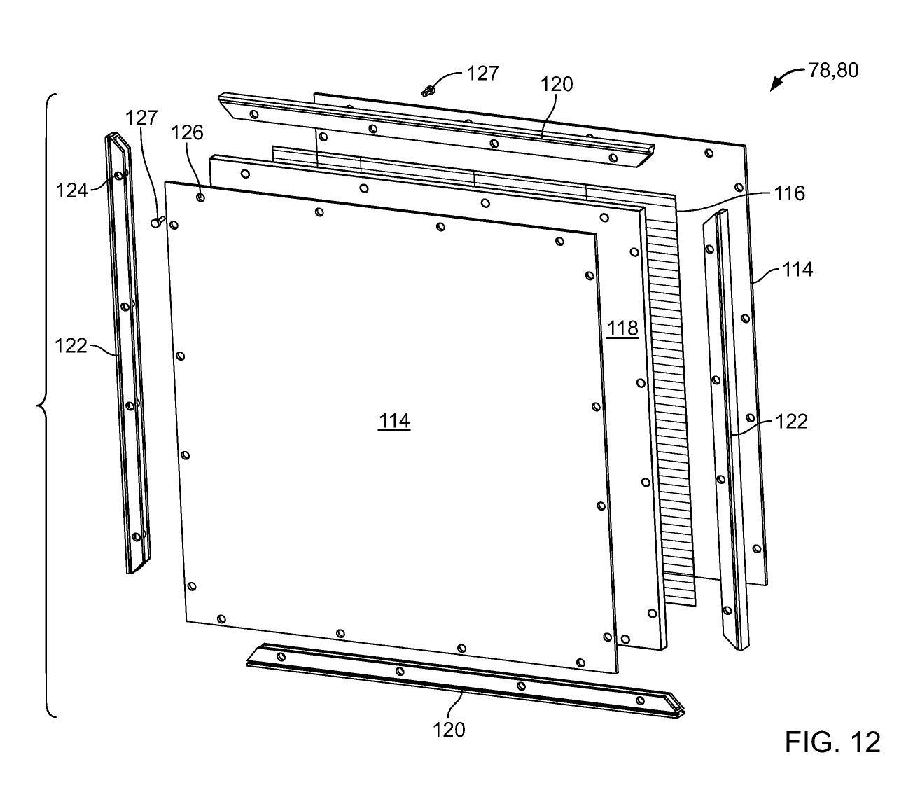

FIG. 12 displays an exploded view of panels 78, 80 which are laminate boards including several flame-resistant layers. Two outer plastic sheets 114 sandwich a hardware cloth (wire mesh) sheet 116 and an expanded polystyrene (EPS) (i.e., foam) board 118. Outer plastic sheets 114 are thin, rigid, non-porous plastic sheets onto which lightweight materials (e.g., stickers or magnets) can be releasably attached. Example materials from which plastic sheets 114 may be made include vinyl, ABS, polyethylene or any other suitable material. Either or both of plastic sheets 114 may have a glossy, static-cling finish or a matte finish. Hardware cloth sheet 116 is formed from a mesh arrangement of wires and provides panels 78, 80 with magnetically attractive properties for holding magnetic objects (e.g., magnetic stickers) to at least one side of panels 78, 80. Furthermore, mechanical properties of hardware cloth sheet 116 serve to strengthen panels 78, 80. EPS board 118 provides additional rigidity, thickness, and sound-dampening properties to panels 78, 80, while keeping the weight of the overall panels 78, 80 desirably low. In another embodiment, panels 78, 80 include two hardware cloth sheets 116 (one sheet 116 on each side of EPS board 118). In one embodiment, panels 78, 80 have an approximate thickness of 0.5 in. In one embodiment, small-sized panel 78 has an approximate length of 18 in and an approximate width of 19.5 in. In one embodiment, intermediate-sized panel 80 has an approximate length of 36.5 in and an approximate width of 19.5 in.

The various layers of panels 78, 80 are assembled with two horizontally disposed, u-shaped panel frame members 120 and two vertically disposed, u-shaped panel frame members 122 that sandwich plastic sheets 114, hardware cloth sheet 116, and EPS board 118 together. Holes 124 spaced along flanges of panel frame members 120, 122 align with holes 126 spaced along edges of the various panel layers and are sized to accept fasteners 128 that secure the frame members 120, 122 and the various layers to one another.

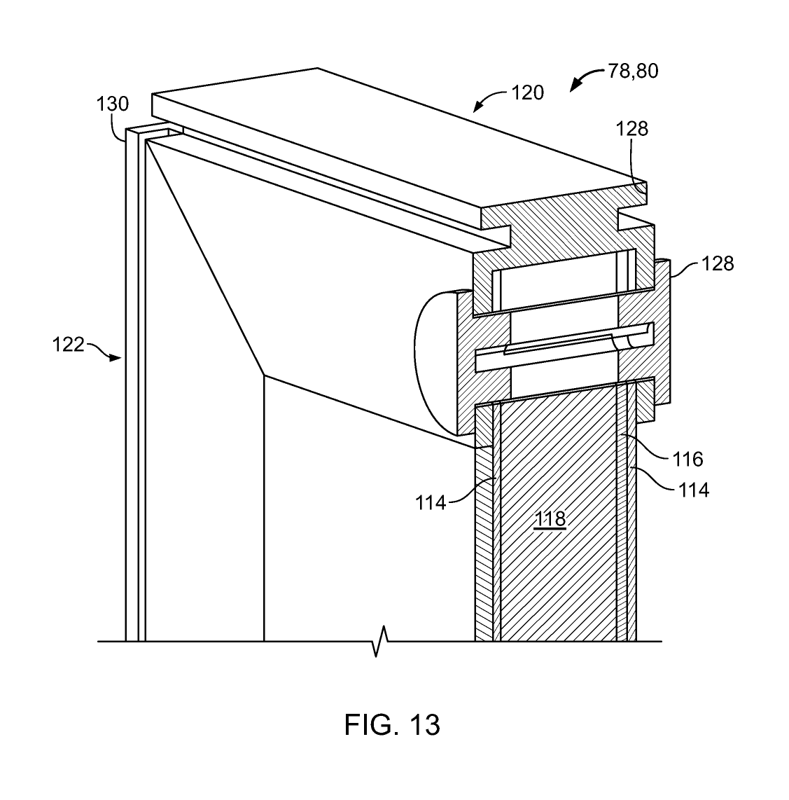

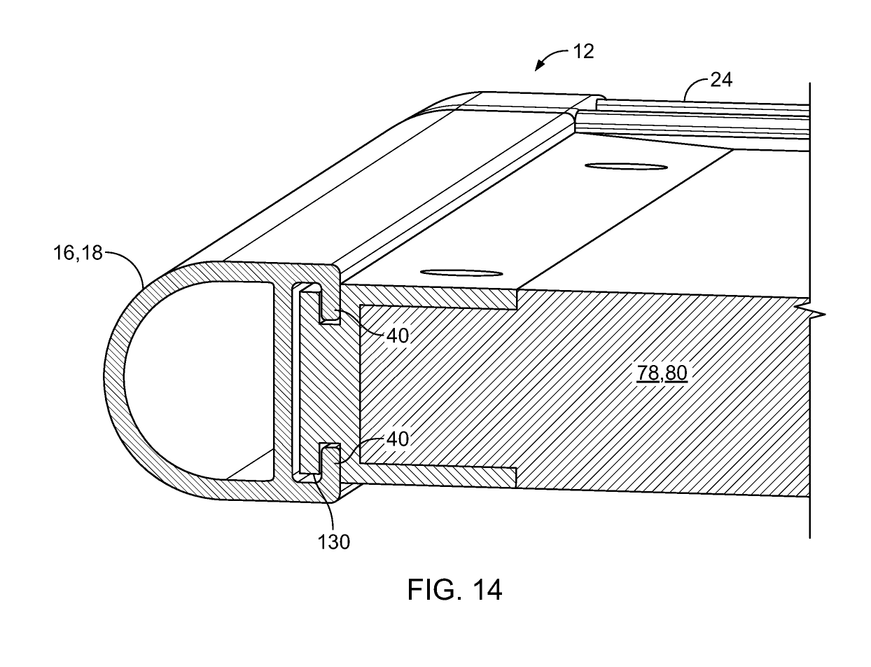

FIGS. 13 and 14 display cross-sectional views of panels 78, 80 and panels 78, 80 assembled with end frame 12, respectively. T-shaped flanges 128, 130 extend from panel frame members 120, 122, respectively. T-shaped flanges 128 are sized to fit within slots 54, 110 of horizontal frame members 22, 24, 82, 86, and t-shaped flanges 130 are sized to slide within slots 42, 102 of vertical frame members 16, 18, 88, 90 such that panels 78, 80 can be releasably assembled with frames 12, 14 of hinged frame 10.

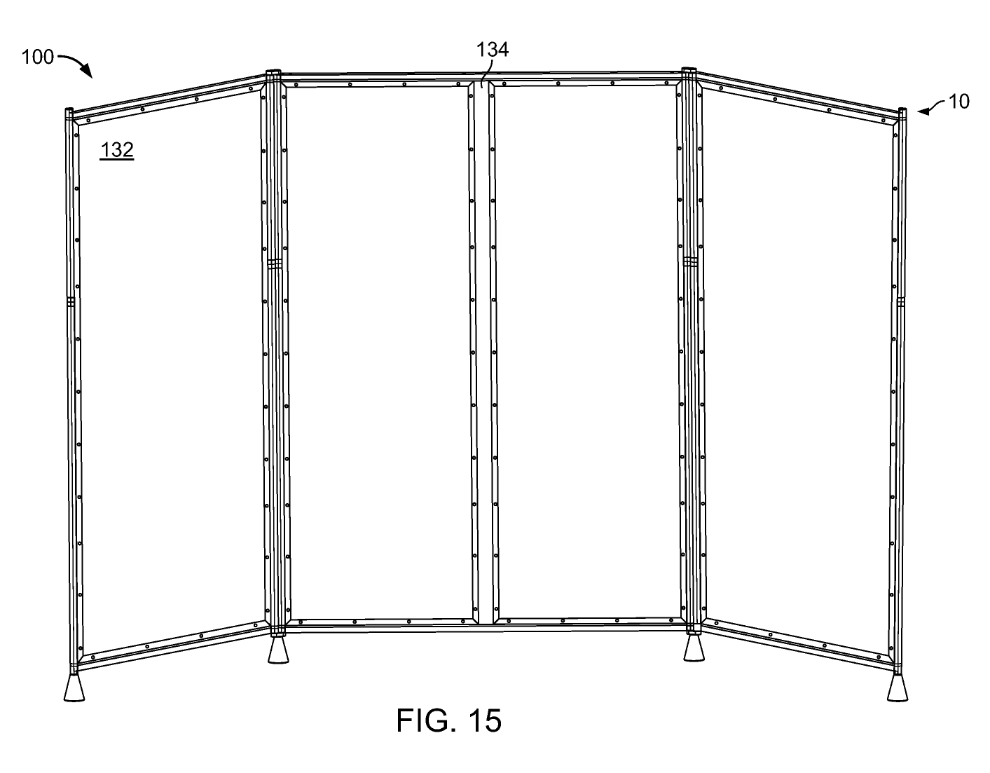

As shown in FIG. 15, hinged panel display 100 can alternatively (or additionally) be assembled with large-sized panels 132 in some embodiments. In the example of FIG. 15, hinged panel display 100 is assembled with hinged frame 10, four large-sized panels 132, a long vertical frame member 134, and two tube connectors 92. Vertical frame member 134 is substantially in similar in construction to vertical frame members 88, 90, with the exception that vertical frame member 134 is of a different length. In one embodiment, long vertical frame member 134 has an approximate length of 55.5. Large-sized panels 132 are substantially similar in construction to small and intermediate-sized panels 78, 80, with the exception that large-sized panels 132 have a different length. In one embodiment, large-sized panel 132 has an approximate length of 55.5 in and an approximate width of 19.5 in.

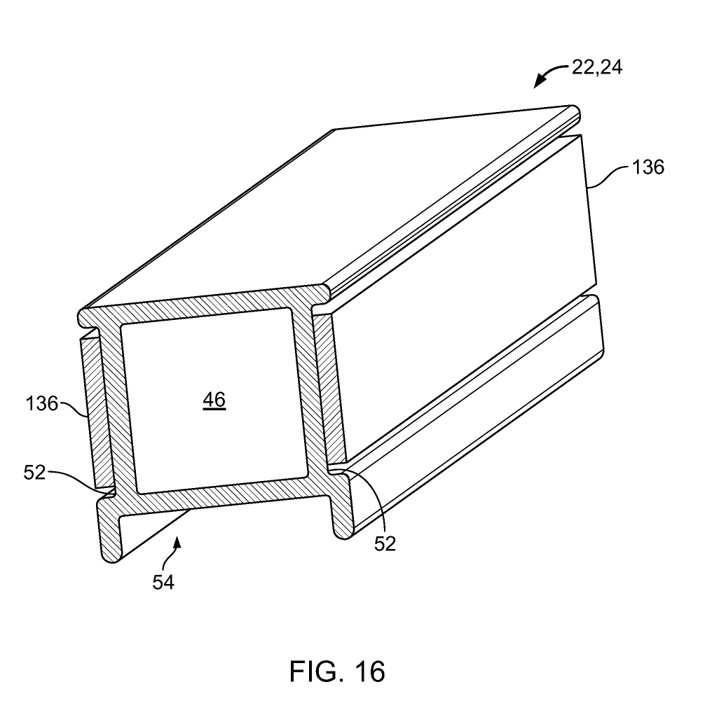

FIG. 16 displays a perspective cross-sectional view of horizontal frame members 22, 24. Strips 136 of fastener material (e.g., strips formed from a Velcro brand hook fastener material) may be attached along elongate recesses 52 to allow for attachment of various display surfaces and other components to either side of frames 12, 14 using an appropriate loop receptive material. In one embodiment, strips 136 of fastener material have an approximate width of 0.5 in. In some embodiments, snap buttons may be used to allow attachment of various display surfaces having complimentary snap button components, instead of or in addition to strips 136 of fastener material.

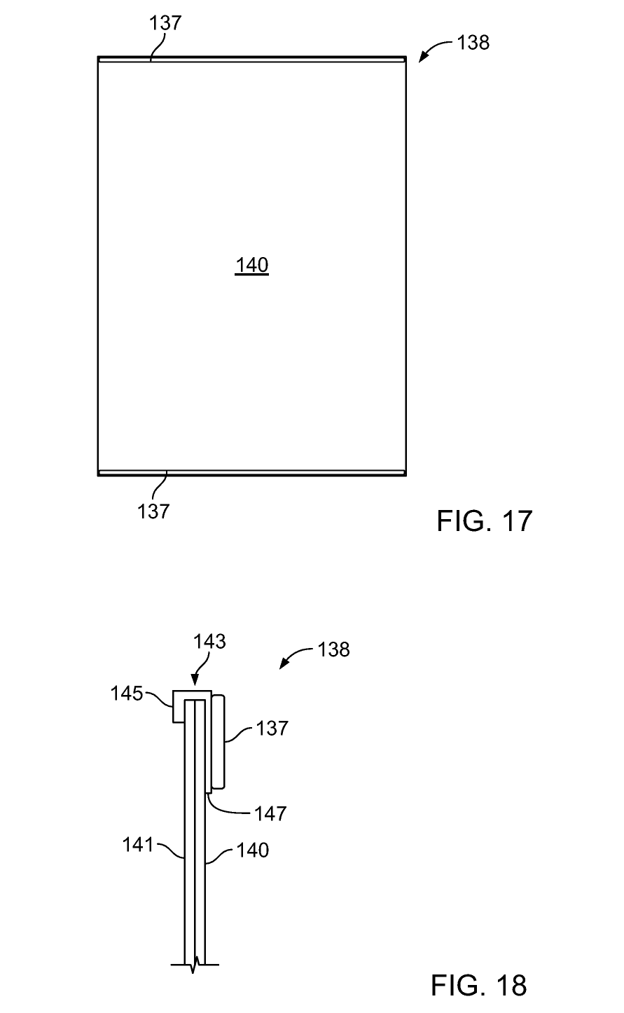

FIGS. 17 and 18 display rear and cross-sectional views, respectively, of a detachable overlay panel 138 that can be affixed to hinged frame 10 at strips 136 of fastener material (see FIG. 16) positioned along horizontal frame members 22, 24. In one embodiment, rear surface 140 of overlay panel 138 is made of a plastic material, such as ABS or polyethylene. A front surface 141 of overlay panel 138 may be made a variety materials designed for releasable attachment of objects to the surface, such as fastener or receptive loop material, felt, cork, chalkboard, and static-cling material. The front and rear surfaces 141, 140 of overlay panel 138 are assembled with a J-shaped perimeter frame 143 having front and rear flanges 145, 147 that extend over edges of the front and rear surfaces 141, 140, respectively. In one embodiment, front and rear flanges 145, 147 have approximate widths of 0.25 in. and 0.5 in., respectively. Strips 137 of receptive loop material (e.g., strips made of Velcro brand receptive loop material) are positioned along top and bottom edges of rear flange 147 for detachable assembly of overlay panel 138 to hinged frame 10. Overlay panel 138 can be appropriately sized to cover a portion or substantially an entire area of frames 12, 14 while still allowing frames 12, 14 to fully pivot with respect to one another. Overlay panels 138 can be affixed to hinged frame 10 with or without panels 78, 80, 132 assembled with hinged frame 10.

As shown in FIG. 19, in some examples, poster hangers 142 can be releasably attached to horizontal frame members 22, 24 at holes in the top surface of horizontal frame members 22, 24, allowing one or more poster bars 144 to be hung on either side of frames 12, 14. Poster bar 144 includes two spaced apart tabs 146 having cutouts sized and aligned to fit around tabs of two poster hangers 142. Poster bar 144 can have a length appropriate to extend the width of end frame 12 or center frame 14 while still allowing frames 12, 14 to fully pivot with respect to one another. Strip 136 of hook fastener material extends along the length of poster bar 144 to allow for releasable attachment of a poster, panel, mural, or other display surface having an appropriate strip of loop receptive material for attachment of the surface to poster bar 144.

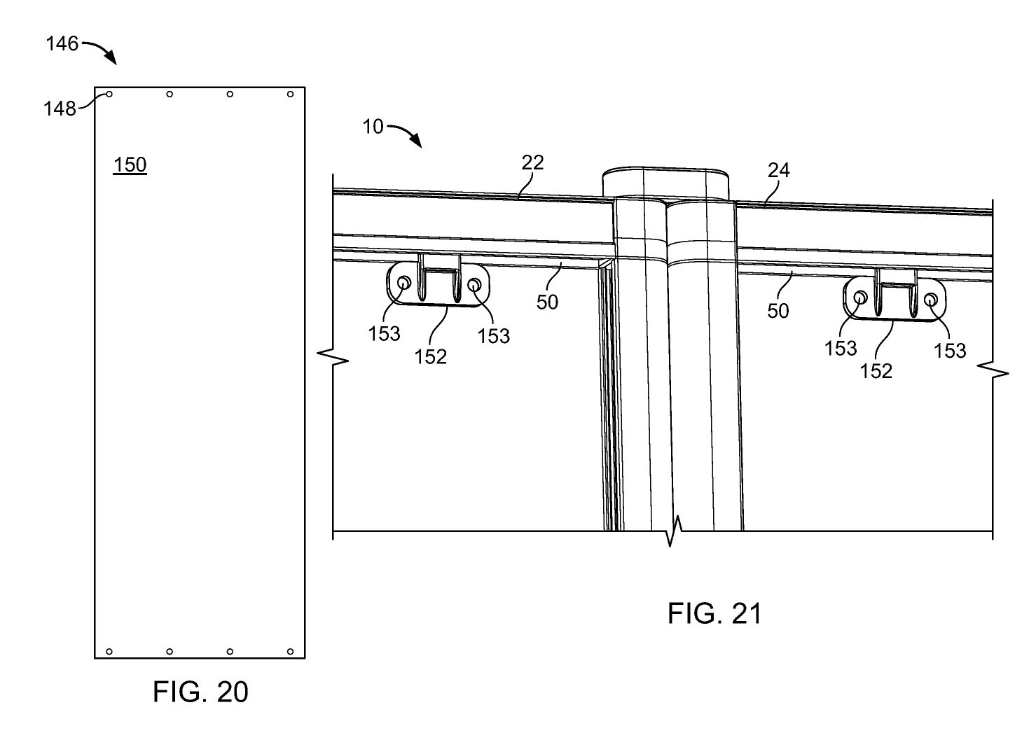

FIG. 20 displays a poster 146 that can be affixed to poster bar 144 at strip 136 of hook fastener material via dots 148 of loop receptive material spaced along top and bottom edges of a rear surface 150 of poster 146. In some examples, a bottom end of poster 144 can hang free such that the bottom row of dots 148 are unattached to hinged frame 10. In other instances, the bottom end of poster 144 is attached to horizontal frame member 22, 24 at strip 136 of hook fastener material via the bottom row of dots 148. Posters 146 can be appropriately sized to cover a portion or substantially the entire surface of any of frames 12, 14 while still allowing frames 12, 14 to fully pivot with respect to one another. Posters 146 can be affixed to hinged frame 10 with or without panels 78, 80, 132 assembled with hinged frame 10. In some examples, poster 146 may display a mural or another type of graphic.

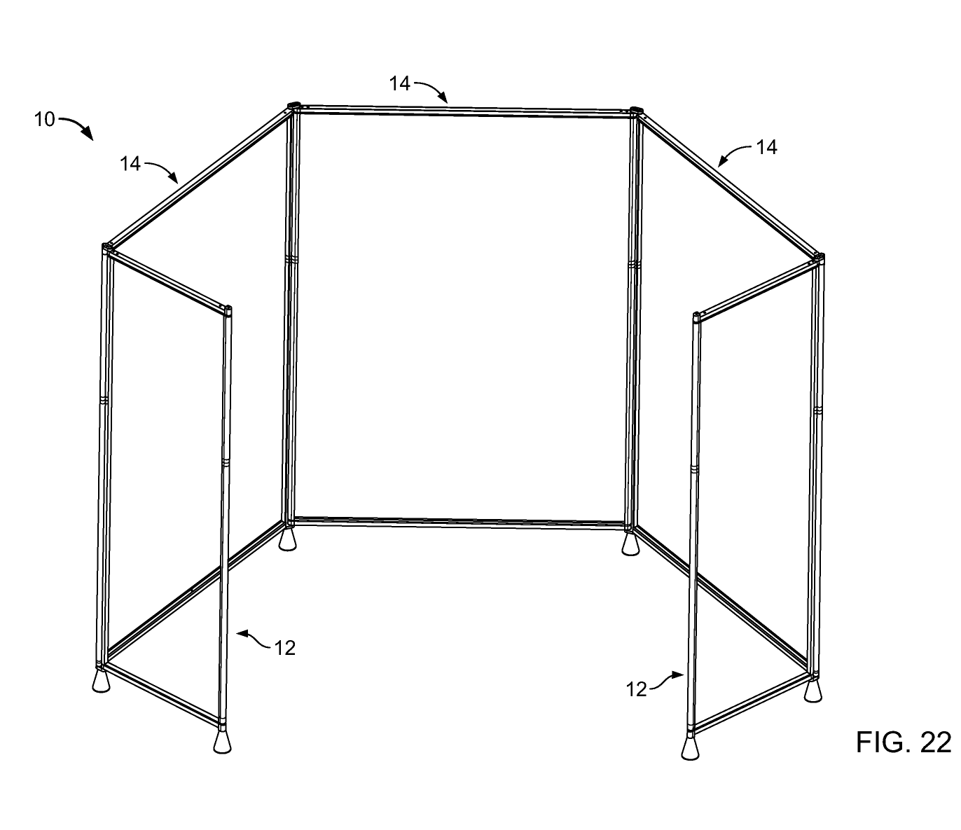

FIG. 21 displays wall hooks 152 that can be attached to inner surfaces of protrusions 50 extending from horizontal frame members 22, 24 for hanging hinged frame 10 on a wall. Accordingly, each wall hook 152 includes two holes 153 through which fasteners can be inserted for mounting hinged frame 10 on the wall.

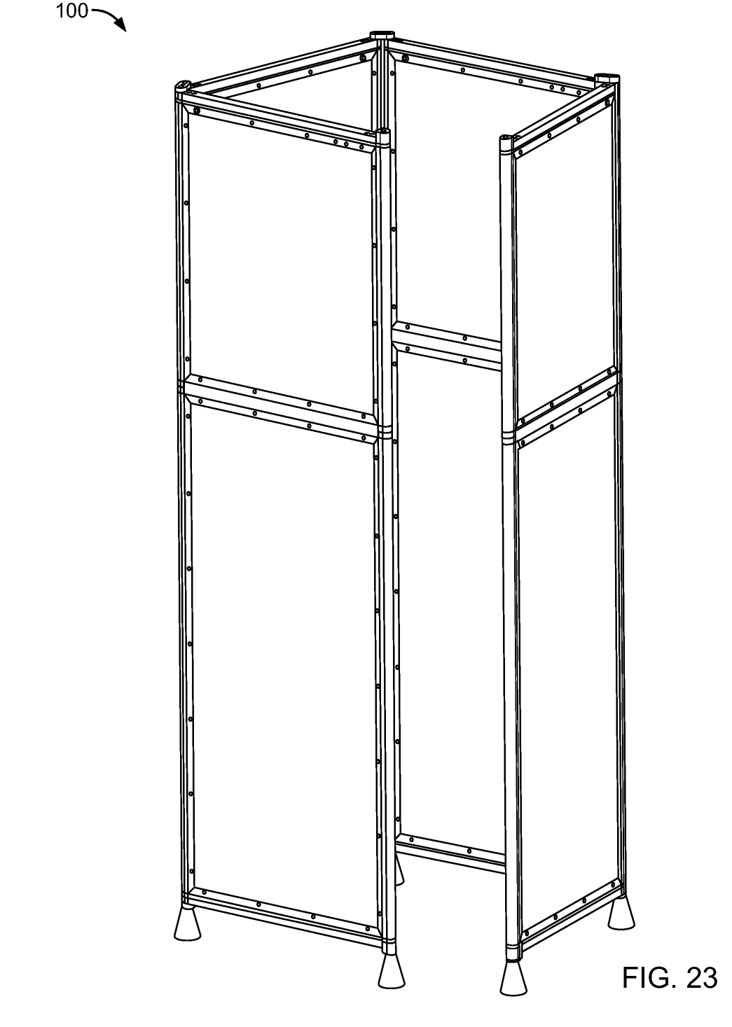

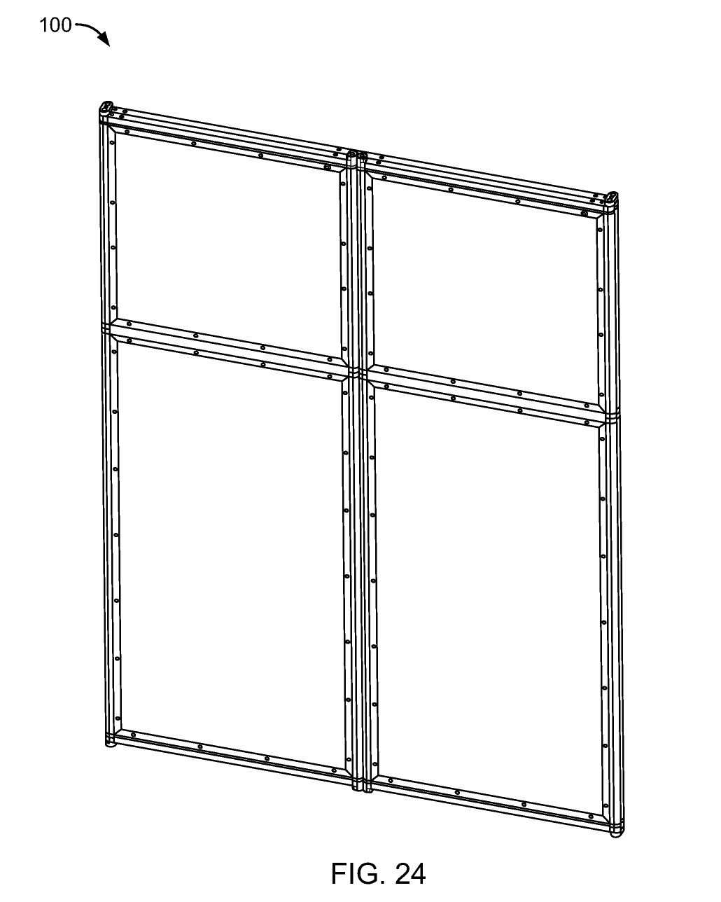

As shown in FIGS. 22-24, hinged frame 10 can be assembled with a variable number of frames 12, 14 and panels 78, 80, 132 and with or without frame feet, providing a wide variety of configurations of hinged frame 10 and hinged panel display 100. In the embodiment of FIG. 22, hinged frame 10 is assembled with two end frames 12 and three center frames 14 and arranged in a substantially open configuration. In the embodiments of FIG. 23 and FIG. 8, hinged panel display 100 is assembled with four end frames, four small-sized panels 78, and four intermediate-sized panels 80 and arranged in partially closed and open configurations, respectively. In the example of FIG. 24, hinged panel display 100 (as assembled in FIG. 8) is arranged in a flat, collapsed configuration (without frame feet 34), which may be desirable for storing hinged panel display 100 in a relatively small or narrow space. Other combinations of frames, panels, and panel arrangements are possible. For example, the end and center frames 12, 14 may include only one row of panel sections, which may be desirable in a case where the hinged panel display 100 is to sit atop a table surface, such as for a science fair. In other embodiments, an additional frame forming a single panel section may extend off an upper, outer vertical frame of the hinged frame 10.

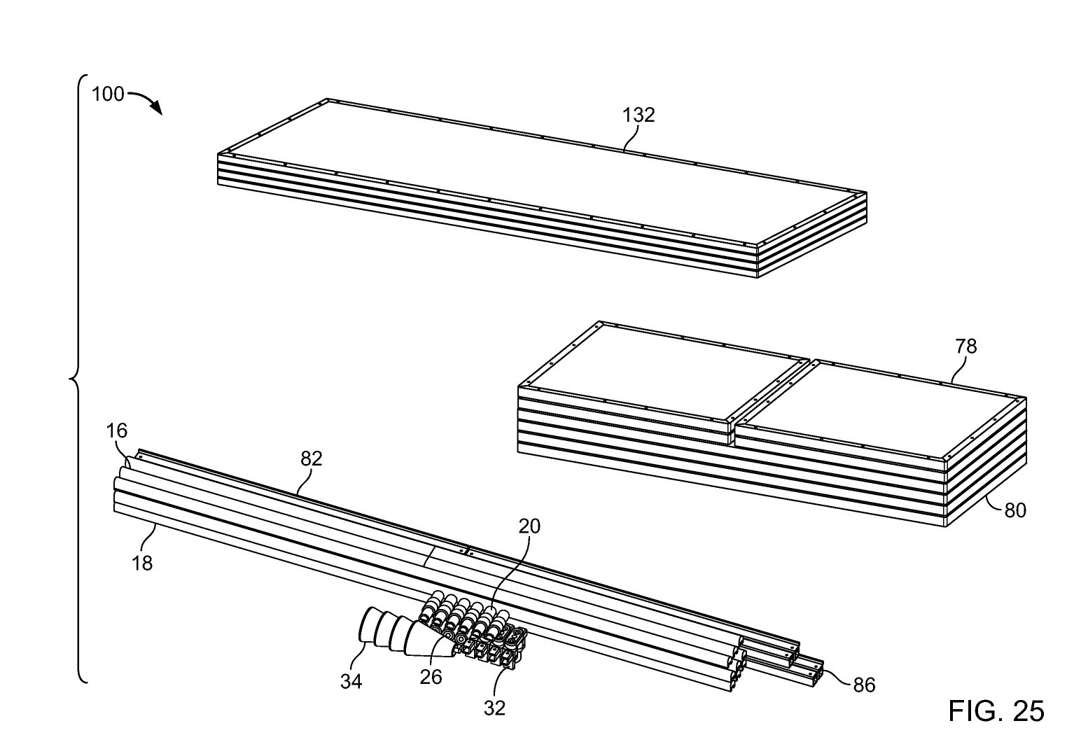

As shown in FIG. 25, hinged panel display 100 may be shipped as an unassembled system of individual components (not shown to scale) and subsequently be assembled in a variety of configurations at a desired location, such as a classroom or a daycare center.

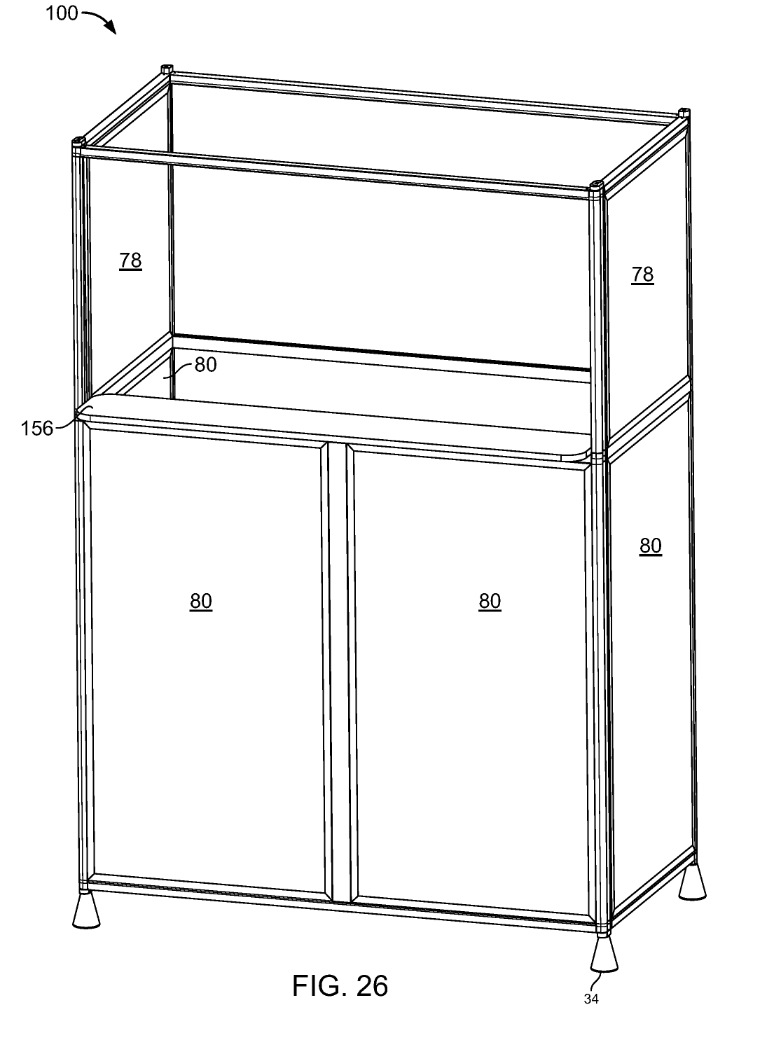

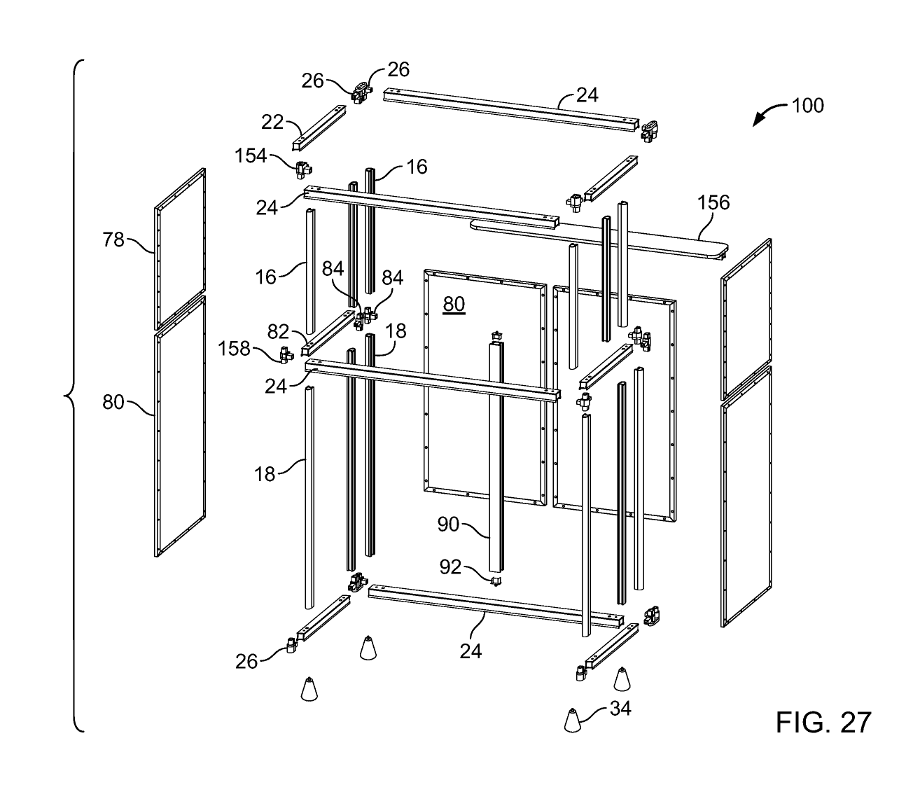

FIGS. 26 and 27 illustrate front and exploded rear perspective views, respectively, of a hinged panel display arranged in a semi-closed configuration as a puppet theater 100. Left and right sides of puppet theatre 100 are each assembled with one small-sized panel 78, one intermediate-sized panel 80, upper and lower short horizontal frame members 22, one center, short horizontal frame member 82, two vertical frame members 16, two vertical frame members 18, two panel connectors 84, and two corner connectors 26. A front side of puppet theater 100 is assembled with two intermediate-sized panels 80, one center, intermediate-sized vertical frame member 90, two short vertical frame members 16, two long vertical frame members 18, two tube connectors 92, two horizontal frame members 24, four corner connectors 26, two panel connectors 84, and a shelf 156.

A rear side of puppet theater 100 is formed from coupling of left and right sides of puppet theater 100 with two spaced apart long horizontal frame members 24. Top horizontal frame member 24 of the rear side of puppet theatre 100 is coupled to horizontal frame member 22 of the left and right sides of puppet theater 100 with two opposing cube corner connectors 154 of the front side of puppet theatre 100. Cube corner connectors 154 include a D-shaped projection sized to fit within D-shaped channel 38 of vertical bars 16 and two square projections sized to fit within square-shaped channels 46 of horizontal frame member 24. Center horizontal frame member 24 of the rear side of puppet theatre 100 is coupled to horizontal frame member 22 of the left and right sides of puppet theater 100 with two opposing middle cube connectors 158 of the front side of puppet theatre 100. Middle cube connectors 158 include two D-shaped projections sized to fit within D-shaped channel 38 of vertical bars 16, 18 and two square projections sized to fit within square-shaped channels 46 of horizontal frame member 24. Shelf 156 is coupled to vertical frame members 16, 18 of the front side of puppet theatre 100 with two opposing panel connectors 84. Shelf 156 is coupled to intermediate-sized vertical frame member 90 with tube connector 92. Puppet theater 100 further includes four frame feet 34 extending from lower corner connectors 26.

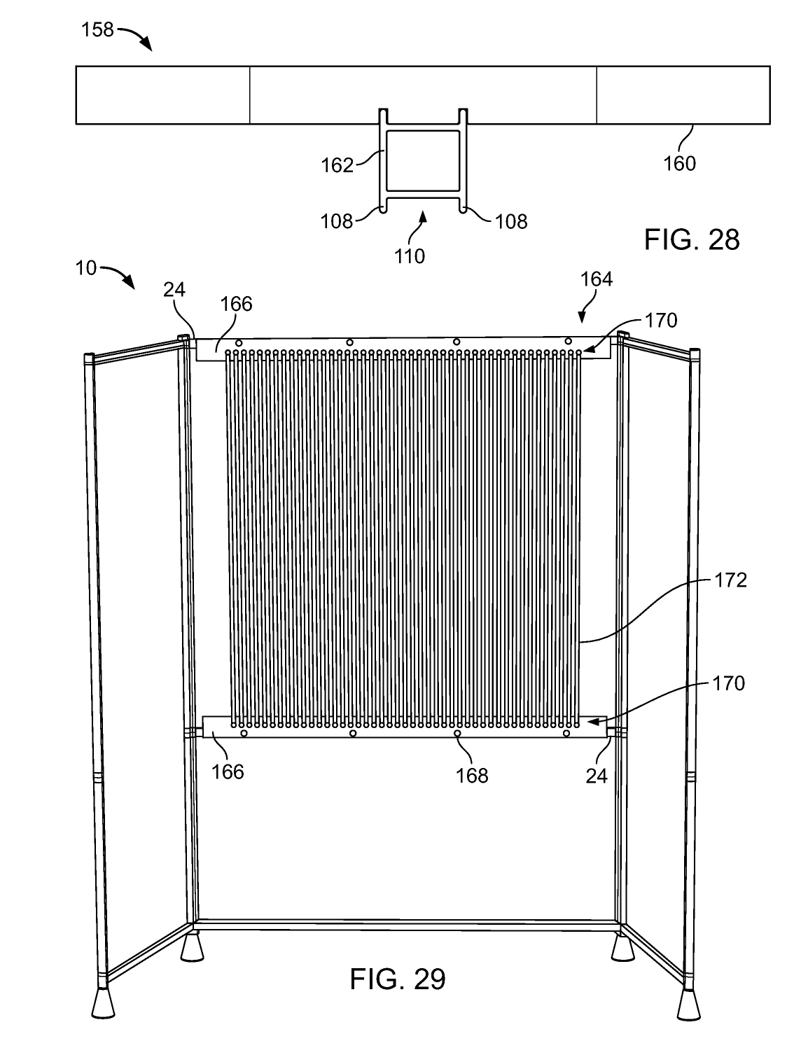

As shown in FIG. 28, shelf 156 has a broad top surface 158 and an opposing broad lower surface 160 from which an elongate rectangular wall 162 extends to form square-shaped channel 106 sized to engage square-shaped projections of panel connectors 84. Two protrusions 108 extend from wall 162 to form an elongate recess 110 sized to slideably couple with panels 78, 80 (as do horizontal frame members 22, 24).

Referring again to FIGS. 26 and 27, intermediate-sized panels 80 are installed across center frame 14 of puppet theatre 100, thereby providing a semi-closed arrangement of the hinged panel display. An open space located above intermediate-sized panels 80 provide an area where a backdrop scene for a puppet show may be affixed to puppet theatre 100 using strips 136 of faster material affixed to elongate recesses 52 of horizontal frame member 24 or to a poster bar 144 hung from poster hangers 142 assembled with horizontal frame member 24. In some embodiments, puppet theatre 100 may include a different arrangement or a different number of panels 78, 80. In some examples, a curtain or other type of covering may be hung from any horizontal frame member 22, 24 of a frame section where a panel 78, 80 is not installed.

FIG. 29 displays a weaving loom assembly 164 installed on hinged frame 10. Weaving loom assembly 164 includes two loom bars 166 attached via fasteners 168 to top and center horizontal frame members 24. A row of pegs 170 extends from each loom bar 166 and provide a surface upon which a string 172 can be vertically and alternately woven about pegs 170. In one embodiment, pegs 170 are spaced approximately 0.5 in apart from one another. In one embodiment, loom bars 166 have an approximate length of 38.5 in. In some embodiments, panels 78, 80, 132, overlay panels 138, and posters 146 may be assembled with hinged frame 10 in addition to weaving loom assembly 164. In some examples, horizontal frame member 24 of hinged frame 10 and loom bar 166 may be shipped as a preassembled unit (e.g., horizontal frame member 24 and loom bar 166 may be preassembled with one or more rivets).

While hinged panel display 100 has been described with respect to example hinged frame 10, hinge 32, panels 78, 80, 132, various horizontal and vertical frame members 16, 18, 22, 24, 82, 86, 88, 90, 120, 122, 128, 130, 134, various connectors 20, 26, 28, 84, 92, 154, and certain configurations (e.g., the open and the puppet theatre configurations), other examples may also be possible. For instance, panels 78, 80, 132 may include a subset of the laminate layers 114, 116, 118 described or may include layers made of additional materials. In some embodiments, any of assembled hinged frame 10, horizontal and vertical frame members 16, 18, 22, 24, 82, 86, 88, 90, 120, 122, 128, 130, 134, and panels 78, 80, 132 may have different dimensions than the example dimensions provided. In some cases, hinged frame 10, hinged panel display 100, and puppet theatre 100 can be assembled with any number of frames 12, 14, panels 78, 80, 132, overlay panels 138, and posters 146 and be arranged in a variety of configurations to form any number of stable structures having polygonal footprints.

Thus, while a number of examples have been described for illustration purposes, the foregoing description is not intended to limit the scope of the invention, which is defined by the scope of the appended claims. There are and will be other examples and modifications within the scope of the following claims.

1. A configurable panel display, comprising:
a plurality of panel frames configurable to support respective panels, adjacent ones of the panel frames being pivotably connected along opposing edges such that the configurable panel display is foldable to a state in which the adjacent ones of the panel frames are overlapped and parallel, each panel frame having intersecting sides formed by tubular frame members; and
a cap hinge assembly pivotably connecting two adjacent ones of the panel frames, each cap hinge assembly including:
two frame corner pieces, each frame corner piece interconnecting tubular frame members of two intersecting sides of a respective one of the adjacent ones of the panel frames, each frame corner piece comprising:
projections received within the interconnected tubular frame members, and
a central corner piece body from which each of the projections integrally extends, the central corner piece body defining a hole extending inward from a shoulder of the central corner piece body,
a hinge cap spanning the two frame corner pieces, and
two fastening members extending perpendicular to the hinge cap and positioned to engage a respective one of the frame corner pieces, each fastening member having a shoulder bearing against the shoulder of the central corner piece body of the respective one of the frame corner pieces and allowing the two frame corner pieces to each independently pivot with respect to the hinge cap.

2. The configurable panel display of claim 1, wherein the hinge cap defines a mounting aperture disposed between the two fastening members and open at an exposed surface of the cap.

3. The configurable panel display of claim 2, further comprising a display foot secured to the hinge cap at the mounting aperture and extending from the exposed surface of the cap.

4. The configurable panel display of claim 1, wherein at least two components of the cap hinge assembly are secured to each other with clips.

5. The configurable panel display of claim 1, wherein the hole within the central corner piece body is sized to accept a respective fastening member of the cap hinge assembly.

6. The configurable panel display of claim 1, wherein the projections have interference detents that bear against inner surfaces of the tubular frame members to secure the cap hinge assembly to the adjacent ones of the panel frames.

7. The configurable panel display of claim 1, wherein the opposing edges of the panel frames each comprise multiple tubular frame members joined by a connector to form a single, linear frame edge, each connector having projections received within the multiple tubular frame members.

8. The configurable panel display of claim 1, wherein one of the tubular frame members forms an upper edge of one of the panel frames.

9. The configurable panel display of claim 1, further comprising panels supported by and spanning respective ones of the panel frames.

10. The configurable panel display of claim 9, wherein at least one of the panels comprises a laminate with a core between surface coverings, one of the surface coverings providing a relatively smooth, non-porous surface suitable for non-adhesively supporting flexible sheets.

11. The configurable panel display of claim 10, wherein at least one of the panels has a magnetically attractable surface.

12. The configurable panel display of claim 10, wherein the core comprises one or more wire portions.

13. The configurable panel display of claim 10, wherein the panel comprises a perimeter frame extending about the laminate, edges of the laminate extending into channels of the perimeter frame.

14. The configurable panel display of claim 13, wherein the perimeter frame defines grooves extending along opposite sides of edges of the panel, ribs of the tubular frame members of the panel frames received within the grooves and securing the panels to the panel frames.

15. The configurable panel display of claim 10, wherein the panels each have a thickness measured between broadest sides of the panel, and wherein the panel frames are of a greater thickness than a combined thickness of one or more components of the panels.

16. The configurable panel display of claim 1, wherein the adjacent ones of the panel frames each have a thickness, and wherein first and second rotation axes defined by the cap hinge assembly are spaced apart a distance at least as great as half the sum of the thicknesses of the adjacent ones of the panel frames, such that the adjacent ones of the panel frames are pivotable with respect to each other to place the adjacent ones of the panel frames in an overlapped, parallel relation.

17. The configurable panel display of claim 16, wherein the adjacent ones of the panel frames are each rotatable about the cap hinge assembly through an angle of at least 180 degrees, such that the adjacent ones of the panel frames are pivotable in either of two directions to place the adjacent ones of the panel frames in an overlapped, parallel relation.

18. The configurable panel display of claim 1, comprising at least three panel frames connected in series by cap hinge assemblies and foldable to place distal vertical edges of the configurable panel display adjacent one another, thereby forming a three-dimensional structure having a polygonal footprint.

19. The configurable panel display of claim 1, comprising a middle panel frame disposed between and pivotably connected to two side panel frames by hinge cap assemblies, and a middle panel supported by and spanning a width of a lower portion of the middle panel frame, the middle panel frame spanning an opening above the middle panel.

20. The configurable panel display of claim 19, further comprising a drape depending from an upper edge of the middle panel frame into the opening, such that the configurable panel display is configurable as a puppet theatre.

21. The configurable panel display of claim 19, further comprising two rows of pegs disposed on opposite sides of the opening, the pegs aligned to form an educational loom.

22. The configurable panel display of claim 1, further comprising one or more removable, flexible overlay panels secured to and spanning the panel frames.
